(19) United States
(12) Patent Application Publication
(10) Pub. No.: US 2005/0035957 A1
(43) Pub. Date: Feb. 17, 2005

(54) DISPLAY CONTROLLER AND RELATED METHOD FOR CALIBRATING DISPLAY DRIVING VOLTAGES ACCORDING TO INPUT RESISTANCE OF A MONITOR

(76) Inventors: Chi-Yang Lin, Taipei Hsien (TW); Peter Chen, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/708,638

(22) Filed: Mar. 17, 2004

(30) Foreign Application Priority Data
Aug. 13, 2003 (TW) 092122249

(51) Int. Cl. G09G 5/00

(52) U.S. Cl. 345/204

(57) ABSTRACT

A display controller and a related method for calibrating display driving voltages according to input resistance of a monitor. The display controller has a digital-to-analog converter (DAC) for converting a display data into a corresponding display driving voltage. The DAC has a current mirror circuit for converting the display data to an output current in proportion to a reference current according to a mirror ratio, and a voltage calibration circuit for adjusting the mirror ratio according to the display driving voltage and a predetermined display driving voltage to make the display driving voltage approach the predetermined display driving voltage with an adjustment of the output current.

### BACKGROUND OF INVENTION

1. Field of the Invention

The present invention relates to a display controller. In particular, the present invention discloses a display controller and a method capable of calibrating display driving voltages according to input resistance of a monitor.

2. Description of the Prior Art

Please refer to FIG. 1, which is a block diagram of a prior art computer system 10. The computer system 10 includes a central processing unit (CPU) 12, a north bridge circuit 14, a system memory 16, a display controller 18, and a monitor 20. The CPU 12 is used to control operation of the computer system 10. The north bridge circuit 14 is used to arbitrate signal transmission among the system memory 16, the display controller 18, and the CPU 12. The system memory 16 is used to store computational data of the CPU 12, and the display controller 18 is used to output video signals for driving the monitor 20 to show corresponding images. The display control 18 includes a graphics chip 22, a video memory 24, and a digital-to-analog converter (DAC) 26. In addition, the video memory 24 has a computation buffer (a Z-buffer or a texture buffer for example) 28 and a frame buffer 30. The graphics chip 22 is capable of processing 2D and 3D graphics data, and stores the calculation results in the computation buffer 28. In addition, the graphics chip 22 stores display data (gray levels for instance) corresponding to the pixels of the monitor 20 in the frame buffer 30. Then, the DAC 26 converts the display data (digital signals) into corresponding display driving voltages (analog signals), and outputs the display driving voltages to the monitor 20 for driving the pixels to show corresponding images.

With regard to a general cathode ray tube (CRT) monitor, its standard input resistance is defined to be 75 ohms. That is, the manufacture of the display controller 18 needs to obey the specification for setting a correct mapping relation between the display data (digital signals) and the display driving voltage (analog signals). However, the manufactured monitor 20 does not perfectly correspond to the ideal input resistance. Therefore, monitors 20 may have different input resistance (75±Δ

R ohms) deviated from the ideal one (75 ohms). When the same display controller 18 is used for driving different monitors 20, two different images associated with the same display data are shown on different monitors 20. The display quality provided by the display controller 18 is deteriorated owing to the input resistance variations inherent to monitors 20.

### SUMMARY OF INVENTION

It is therefore a primary objective of this invention to provide a display controller and a method capable of calibrating display driving voltages according to input resistance of a monitor.

Briefly summarized, the preferred embodiment of the present invention provides a display controller for driving a monitor. The display controller comprises a graphics chip for outputting a display data and a converter for converting the display data into a display driving voltage. The converter has a current mirror circuit for generating an output current according to a reference current and the display data, wherein the output current and the reference current correspond to a mirror ratio, and the output current is delivered to the monitor for generating the display driving voltage. The converter also contains a voltage calibration circuit for modifying the mirror ratio according to the display driving voltage and a predetermined display driving voltage and adjusting the output current to drive the display driving voltage to approach the predetermined display driving voltage.

In addition, the preferred embodiment of the present invention provides a method for calibrating a display driving voltage. The method includes converting a display data into an output current according to a reference current, the output current and the reference current corresponding to a mirror ratio, the output current being used for generating the display driving voltage, and comparing the display driving voltage and a predetermined display driving voltage for modifying the mirror ratio and adjusting the output current to drive the display driving voltage to approach the predetermined display driving voltage.

It is an advantage of the present invention that a DAC has a voltage calibration circuit. The claimed voltage calibration circuit first determines a gain value associated with display driving voltages through a calibration process, and then the DAC adjusts following display driving voltages according to the chosen gain value. For monitors with different input resistance, the claimed display controller is capable of generating identical display driving voltages for driving the monitors to show images corresponding to the same display data. The same image, therefore, is successfully shown on different monitors, and the display quality is greatly improved owing to the claimed voltage calibration circuit.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a prior art computer system.

FIG. 2 is a block diagram of a computer system according to the present invention.

FIG. 3 is a circuit diagram of a DAC shown in FIG. 2.

FIG. 4 is a circuit diagram of a mirror ratio controller shown in FIG. 3.

FIG. 5 is a diagram illustrating operation of a state machine shown in FIG. 3.

### DETAILED DESCRIPTION

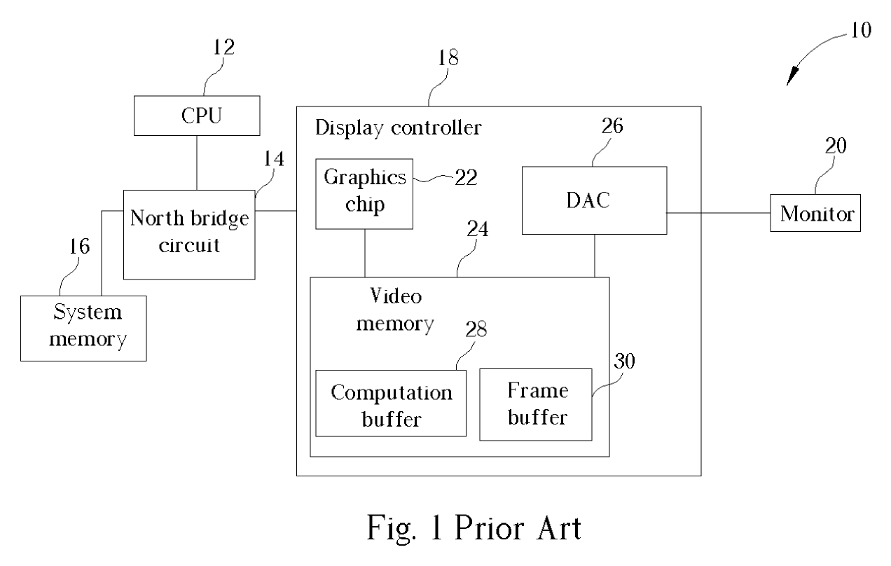

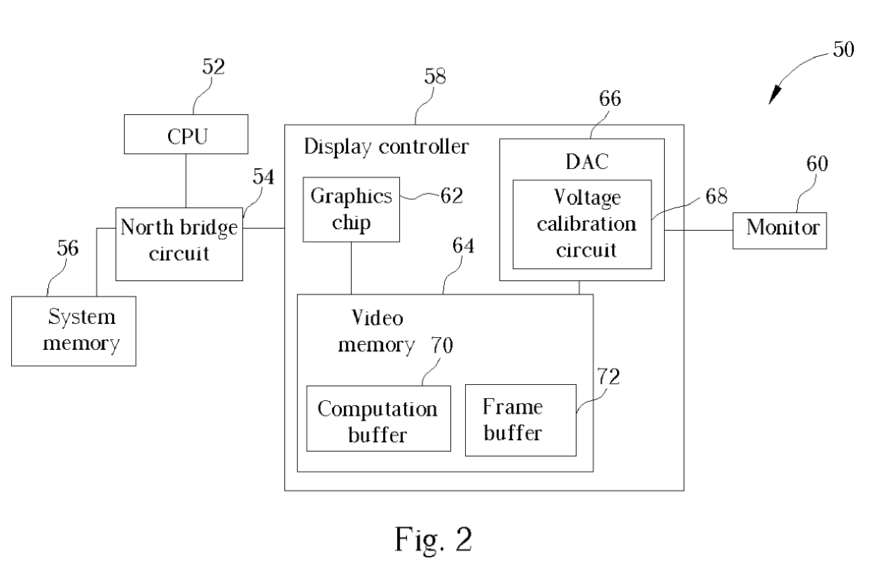

Please refer to FIG. 2, which is a block diagram of a computer system according to the present invention. Please note that the components (the CPU 52, the north bridge circuit 54, the system memory 56, the display controller 58, the monitor 60, the graphics chip 62, the video memory 64, the DAC 66, the computation buffer 70, or the frame buffer 72 for example) shown in FIG. 2 and the components shown in FIG. 1 having the same name correspond to the identical functionality, and the lengthy description is not repeated. The only difference between the computer systems 10, 50 is that the DAC 66 comprises a voltage calibration circuit 68. The voltage calibration circuit 68 is capable of calibrating display driving voltages according to the input resistance of the monitor 60, and outputs the adjusted display driving voltages to the monitor 60 for driving corresponding pixels to show images.

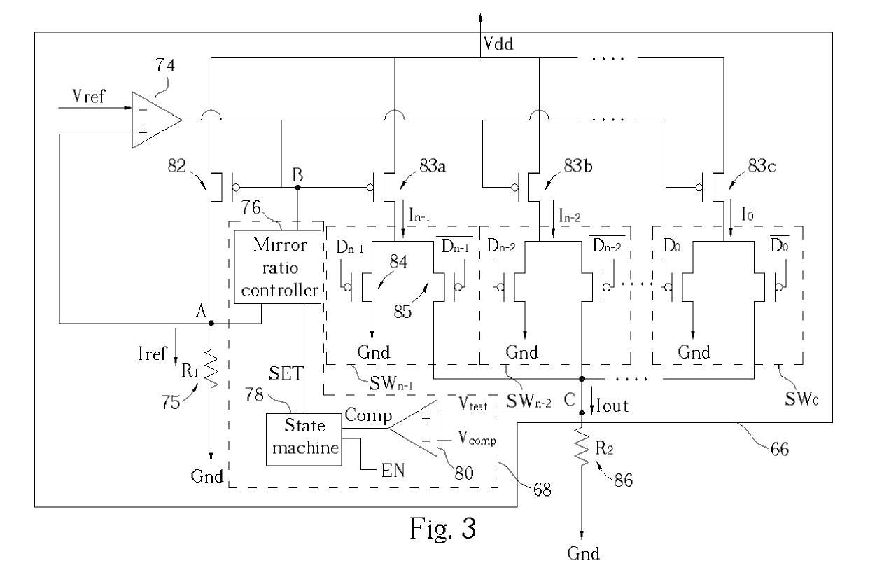

Please refer to FIG. 3, which is a circuit diagram of the DAC 66 shown in FIG. 2. The DAC 66 adopts a current mirror architecture to generate an output current Iout. The operational amplifier (OP) 74 functions as a buffer. The voltage level at node A is a reference voltage Vref, and a reference current Iref passing the resistor 75 with R1 ohms is equal to Vref/R1. Because the reference voltage Vref and the resistance R1 are fixed values respectively, the reference current Iref can be regarded as a current source. If the mirror ratio controller 76 is not enabled yet, node A, therefore, is electrically connected to node B. A transistor 82 and a transistor 83a are connected to establish a current mirror. Therefore, the currents delivered by two current routes built by the transistors 82, 83a correspond to a mirror ratio. Similarly, the transistor 82 and a transistor 83b establish a current mirror, and the transistor 82 and a transistor 83c establish a current mirror as well. Actually, n transistors and the transistor 82 can be connected by a current mirror means for forming a plurality of mirror currents Iₙ₋₁, Iₙ₋₂, . . . , I₀. Suppose that a W/L ratio of the transistor 83a is 2ⁿ⁻¹*L times as great as a W/L ratio of the transistor 82. Therefore, the mirror current Iₙ₋₁ is equal to 2ⁿ⁻¹*L*Iref. In addition, a W/L ratio of the transistor 83b is 2ⁿ⁻²*L times as great as the W/L ratio of the transistor 82. Therefore, the mirror current Iₙ₋₂ is equal to 2ⁿ⁻²*L*Iref. Similarly, a W/L ratio of the transistor 83c is 2⁰*L times as great as the W/L ratio of the transistor 82. Therefore, the mirror current I₀ is equal to 2⁰*L*Iref.

In addition, switches SWₙ₋₁, SWₙ₋₂, . . . , SW₀ are used to control magnitude of the output current Iout. Taking the switch SWₙ₋₁ for example, it includes two transistors 84, 85 whose gates are electrically connected to a voltage level and a corresponding inversed voltage level. When the transistor 85 of the switch SWₙ₋₁ is turned on, the mirror current Iₙ₋₁ is successfully transferred to an output port, that is, node C of the DAC 66. Suppose that a bit length of the display data is equal to n, and the display data is composed of data bits Dₙ₋₁, Dₙ₋₂, . . . , D₀ that are used for determining whether corresponding mirror currents Iₙ₋₁, Iₙ₋₂, . . . , I₀ is delivered to node C. Therefore, the output current Iout is expressed as follows:

$$\begin{matrix}Iout = {I}_{n - 1} + {I}_{n - 2} + … + {I}_{0} \\ = {2}^{n - 1} * L * Iref * {D}_{n - 1} + {2}^{n - 2} * L * Iref * \\ {D}_{n - 2} + … + {2}^{0} * L * Iref * {D}_{0}\end{matrix} \qquad Equation ( 1 )$$

If the display data uses 8 bits to represent 256 different gray levels 0-255, the display data “0000000” corresponds to the gray level 0, and the display data “11111111” corresponds to the gray level 255. In other words, when the display data corresponds to the gray level 255, each of the data bits Dₙ₋₁, Dₙ₋₂, . . . , D₀ records the logic value “1”. In addition, the switches SWₙ₋₁, SWₙ₋₂, . . . , SW₀ respectively conduct the mirror currents Iₙ₋₁, Iₙ₋₂, . . . , I₀ to node C. That is, the output current Iout is formed through collecting all of the mirror currents Iₙ₋₁, Iₙ₋₂, . . . , I₀, and the output current Iout equals (2⁷+2⁶+2⁵+2⁴+2³+2²+2¹+2⁰)*L*Iref, that is, 255*L*Iref.

When the display data corresponds to the gray level 0, each of the data bits Dₙ₋₁, Dₙ₋₂, . . . , D₀ records another logic value “0”. In addition, the switches SWₙ₋₁, SWₙ₋₂, . . . , SW₀ respectively conduct the mirror currents Iₙ₋₁, Iₙ₋₂, . . . I₀ to the ground GND instead of node C. Therefore, the output current Iout equals 0 (Iout=0*Iref=0) according to the equation (1). As shown in FIG. 3, node C is connected to the ground GND through the resistor 86, and the resistor 86 is equivalent to the input resistance of the monitor 60. In other words, the voltage at node C is the display driving voltage generated from the DAC 66. If the resistance of the resistor 86 is equal to R2, the display driving voltage is equal to a product of the output current Iout and the resistance R2.

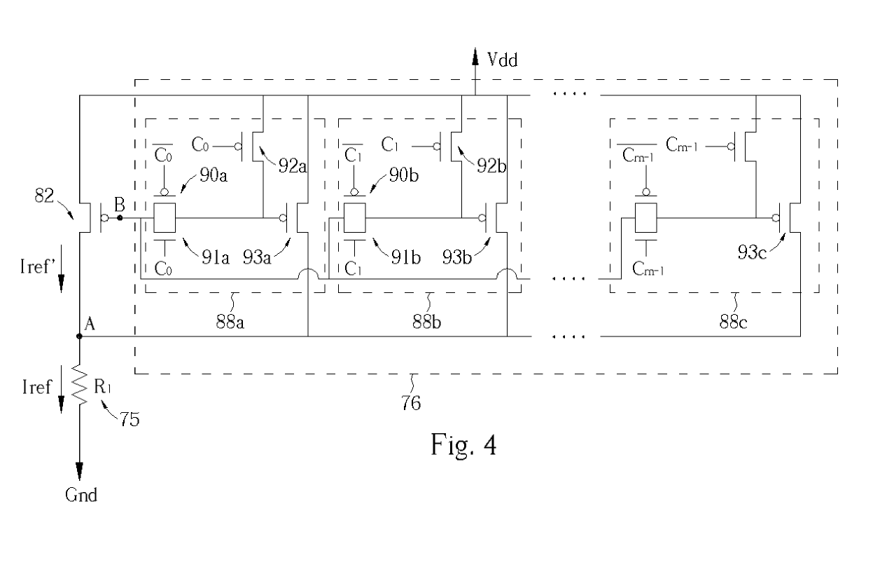

Please refer to FIG. 4, which is a circuit diagram of the mirror ratio controller 76 shown in FIG. 3. The mirror ration controller 76 has a plurality of mirror ratio setting units 88a, 88b, 88c. Please note that only three mirror ratio setting units are shown for simplicity. When the mirror ratio controller 76 is enabled, the mirror ratio setting units 88a, 88b, 88c function as current dividers for adjusting the current Iref that actually passes the transistor 82. Because the reference current Iref is viewed as a current source, the magnitude of the reference current Iref becomes less when more current dividers are activated. Taking the mirror ratio setting unit 88a for example, it includes transistors 90a, 91a, 92a, 93a. The transistors 90a, 91a are a PMOS transistor and an NMOS transistor respectively. If a control bit C₀ corresponds to the logic value “1”, the transistor switch built by the transistors 90a, 91a is switched on for connecting gates of the transistors 82, 93a. However, the transistor 92a is still turned off. With an adequate reference voltage Vref, the transistor 82 enters a saturation state. Please note that the drain, the source, and the gate of the transistor 93a are respectively connected to the drain, the source, and the gate of the transistor 82. Therefore, the transistor 93a enters the saturation state as well. If the W/L ration is K times as great as the W/L ration of the transistor 82, the reference current Iref passing the transistor 82 becomes [1/(1+K)]*Iref. On the contrary, if the control bit C₀ corresponds to another logic value “0”, the transistor switch built by the transistors 90a, 91a is not turned on. As this time, the transistor 92a is turned on so that the gate of the transistor 93a approaches a high voltage level Vdd. Therefore, the transistor 93a is turned off, and the reference current Iref equals the reference current Iref.

Regarding the mirror ratio setting unit 88b, the operation of the mirror ratio setting unit 88b is similar to that of the mirror ratio setting unit 88a mentioned above. If a control bit C₁ corresponds to the logic value “1”, and the W/L ratio of the transistor 93b is 2*K times as great as the W/L ratio of the transistor 82, the reference current Iref passing the transistor 82 becomes [1/(1+2*K)]*Iref. On the contrary, if the control bit C₁ corresponds to the logic value “0”, the reference current Iref is equal to the reference current Iref. Therefore, suppose that the mirror ratio controller 76 comprises m mirror ratio setting units, the control bits C₀, C₁, . . . , Cₘ₋₁ are used to control magnitude of the reference current Iref, and the W/L ratios of the transistors (transistors 93a, 93b for example) are K*2^{T} (0≦

T ≦

m−1) times as great as the W/L ratio of the transistor 82 respectively. For instance, the transistor 93a corresponding to the control bit C has a W/L ratio that is K*2⁰ times as great as the W/L ratio of the transistor 82, the transistor 93b corresponding to the control bit C₁ has a W/L ratio that is K*2¹ times as great as the W/L ratio of the transistor 82, and the transistor 93c corresponding to the control bit Cₘ₋₁ has a W/L ratio that is K*2^{m-1} times as great as the W/L ratio of the transistor 82. According to the prior art superposition principle, the reference current Iref is expressed as follows:

$${Iref}^{′} = \frac{Iref}{\begin{matrix}1 + K * {C}_{0} + {2}^{1} * K * {C}_{1} + … + \\ {2}^{( m - 1 )} * K * {C}_{( m - 1 )}\end{matrix}} \qquad Equation ( 2 )$$

When the voltage calibration circuit 68 is taken into consideration, the reference current Iref expressed by the equation (2) substitutes for the reference current Iref in the equation (1). The output current Iout actually generated from the DAC 66 is described as follows:

$$Iout = ( {2}^{n - 1} * L * {D}_{n - 1} + {2}^{n - 2} * L * {D}_{n - 2} + … + {2}^{0} * L * {D}_{0} ) * \frac{1}{1 + K * {C}_{0} + {2}^{1} * K * {C}_{1} + … + {2}^{( m - 1 )} * K * {C}_{( m - 1 )}} * Iref \qquad Equation ( 3 )$$

When the DAC 66 reads the same data bits Dₙ₋₁, Dₙ₋₂, . . . , D₀ to drive monitors 60 with different input resistances Rᵢₙ(A) and Rᵢₙ(B), the DAC 66 is capable of outputting different output currents Iout(A) and Iout(B) through assigning appropriate values to the control bits C₀, C₁, . . . , Cₘ₋₁ so that the product of the input resistance Rᵢₙ(A) and the output current Iout(A) is equal to the input resistance Rᵢₙ(B) and the output current Iout(B). That is, when the same display data is used to drive different monitors, the DAC 66 generates the same display driving voltage.

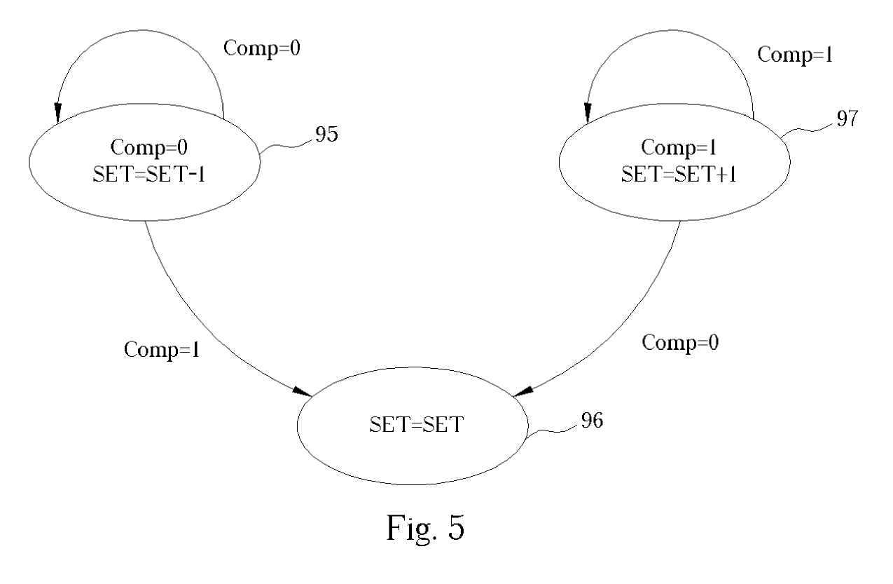

Please refer to FIG. 5, which is a diagram illustrating the operation of the state machine 78 shown in FIG. 3. The state machine 78 outputs a setting value SET to the mirror ratio controller 76. The bit length of the setting value SET equals m, and is composed of control bits C₀, C₁, . . . , Cₘ₋₁. The operation of the state machine 78 corresponds to three operational states 95, 96, 97, and the transitions among the operational states 95, 96, 97 are determined according to a comparison result Comp outputted from the operational amplifier 80. The operational amplifier 80 compares the display driving voltage at node C with a comparison voltage Vcomp. If the display driving voltage is greater than the comparison voltage Vcomp, the comparison result Comp corresponds to a high voltage level. On the contrary, if the display driving voltage is less than the comparison voltage Vcomp, the comparison result Comp corresponds to a low voltage level.

In the preferred embodiment, the comparison voltage Vcomp is a standard display driving voltage associated with a monitor having input resistance equaling 75 ohms. During the calibration process, the DAC 66 continuously generates a display driving voltage Vtest according to a test display data. The display driving voltage Vtest is equal to a product of the output current Iout and the resistance R2 of the resistor 86. If the display driving voltage Vtest at node C is greater than the comparison voltage Vcomp, it means that the input resistance, that is, the resistance R2 of the resistor 86, is greater than a standard value (75 ohms). Therefore, the voltage calibration circuit 68 has to reduce the output current Iout for lowering the display driving voltage Vtest. On the contrary, if the display driving voltage Vtest at node C is less than the comparison voltage Vcomp, it means that the input resistance, that is, the resistance R2 of the resistor 86, is less than the standard value (75 ohms). Therefore, the voltage calibration circuit 68 has to increase the output current Iout for raising the display driving voltage Vtest.

When the calibration process is started, an enabling signal EN activates the state machine 78. Simultaneously, each of the control bits C₀, C₁, . . . , Cₘ₋₂ is initialized. In the preferred embodiment, the most significant bit (the control bit Cₘ₋₁) of the setting value SET is set to the logic value “1”, and each of the remaining control bits C₀, C₁, . . . , Cₘ₋₂ is set to the logic value “0”. In other words, an initial value of the setting value SET is set between a maximum value (each of the control bits C₀, C₁, . . . Cₘ₋₁ corresponds to the logic value “1”) and a minimum value (each of the control bits C₀, C₁, . . . , Cₘ₋₁ corresponds to the logic value “0”). Therefore, the setting value SET can be gradually increased from the initial value toward the maximum value or be gradually decreased from the initial value toward the minimum value, and the goal of tuning the display driving voltage Vtest is successfully achieved. Based on the equation (3), it is obvious that an initial value of the output current Iout is expressed as follows:

$$Iout = ( {2}^{n - 1} + {2}^{n - 2} + … + {2}^{0} ) * L * \frac{1}{1 + {2}^{( m - 1 )} * K} * Iref \qquad Equation ( 4 )$$

The initial output current Iout passing the resistor 86 makes the display driving voltage Vtest at node C less than the comparison voltage Vcomp if the resistance R2 of the resistor 86 is less than the standard value (75 ohms). Then, the comparison result Comp corresponds to the logic value “0”, and the state machine 78 enters the operational state 95. With regard to the setting value SET, it is decreased by 1 so that the control bits Cₘ₋₁ corresponds to the logic value “0”, and remaining control bits C₀, C₁, . . . , Cₘ₋₂ correspond to the logic value “1”. According to the equation (3), the output current Iout is raised. The adjusted output current Iout is expressed as follows:

$$\begin{matrix}Iout = ( {2}^{n - 1} + {2}^{n - 2} + … + {2}^{0} ) * L * \\ \frac{1}{1 + K + {2}^{1} * K + … + {2}^{( m - 2 )} * K} * Iref \\ = ( {2}^{n - 1} + {2}^{n - 2} + … + {2}^{0} ) * L * \\ \frac{1}{1 + ( {2}^{( m - 1 )} - 1 ) * K} * Iref \\ > ( {2}^{n - 1} + {2}^{n - 2} + … + {2}^{0} ) * L * \\ \frac{1}{1 + {2}^{( m - 1 )} * K} * Iref\end{matrix} \qquad Equation ( 5 )$$

Because the output current Iout is increased, the display driving voltage Vtest is accordingly raised. If the display driving voltage Vtest is still less than the comparison voltage Vcomp, the setting value SET is further decreased by 1 for boosting the output current Iout outputted from node C. The above operation is repeated continuously until the display driving voltage Vtest exceeds the comparison voltage Vcomp. Then, the comparison result Comp corresponds to the logic value “1”. At the same time, the state machine 78 enters another operational state 96 from the operational state 95, and holds the setting value SET. In other words, the state machine 78 is not triggered by the comparison result Comp anymore to modify the setting value SET.

Concerning another condition, the initial output current Iout passing the resistor 86 makes the display driving voltage Vtest at node C greater than the comparison voltage Vcomp if the resistance R2 of the resistor 86 is greater than the standard value (75 ohms). Then, the comparison result Comp corresponds to the logic value “1”, and the state machine 78 enters the operational state 97. With regard to the setting value SET, it is increased by 1 so that both of the control bits Cₘ₋₁, C₀ correspond to the logic value “1”, and remaining control bits C₁, . . . Cₘ₋₂ correspond to the logic value “0”. According to the equation (3), the output current Iout is reduced. The adjusted output current Iout is expressed as follows:

$$\begin{matrix}Iout = ( {2}^{n - 1} + {2}^{n - 2} + … + {2}^{0} ) * L * \\ \frac{1}{1 + K + {2}^{( m - 1 )} * K} * Iref \\ = ( {2}^{n - 1} + {2}^{n - 2} + … + {2}^{0} ) * L * \\ \frac{1}{1 + ( 1 + {2}^{( m - 1 )} ) * K} * Iref \\ < ( {2}^{n - 1} + {2}^{n - 2} + … + {2}^{0} ) * L * \\ \frac{1}{1 + {2}^{( m - 1 )} * K}\end{matrix} \qquad Equation ( 6 )$$

Because the output current Iout is reduced, the display driving voltage Vtest is accordingly decreased. If the display driving voltage Vtest is still greater than the comparison voltage Vcomp, the setting value SET is further increased by 1 for reducing the output current Iout outputted from node C. The above operation is repeated continuously until the comparison voltage Vcomp exceeds the display driving voltage Vtest. Then, the comparison result Comp corresponds to the logic value “0”. At the same time, the state machine 78 enters another operational state 96 from the operational state 97, and holds the setting value SET. In other words, the state machine 78 is not triggered by the comparison result Comp anymore to modify the setting value SET.

Generally speaking, the state machine 78 is built by a plurality of flip-flops. After the state machine 96 enters the operational state 96, the state machine, therefore, stops flip-flops from being triggered to achieve the objective of holding the setting value SET. When the DAC 66 starts converting the digital display data into analog display driving voltages, the setting value SET controls the mirror ratio 76 to adjust the display driving voltages corresponding to different gray levels. In the preferred embodiment, the mirror ratio setting units 88a, 88b, 88c of the mirror ratio controller 76 respectively correspond to different W/L ratios. Therefore, the mirror ratio setting units 88a, 88b, 88c have different adjustment magnitude for the reference current Iref. However, the mirror ratio setting units 88a, 88b, 88c are capable of having the same W/L ratio for tuning the reference current Iref. That is, the total number of the selected mirror ratio setting units dominates the reference current Iref. Therefore, more mirror ratio setting units are increased to lower the reference current Iref when the setting value SET is increased, and fewer mirror ratio setting units are decreased to boost the reference current Iref when the setting value SET is decreased.

In contrast to the prior art, the DAC of the claimed display controller has a voltage calibration circuit. When the calibration process begins, the DAC outputs a test driving voltage according to a test display data voltage for driving a monitor. Then, the voltage calibration circuit continuously adjusts the test driving voltage according to a comparison between the test driving voltage and a target driving voltage until the test driving voltage approaches the target driving voltage. The voltage calibration circuit according to the present invention first determines a gain value associated with the display driving voltages through the calibration process, and then the DAC adjusts following display driving voltages according to the chosen gain value. In other words, for monitors with different input resistance, the claimed display controller is capable of generating identical display driving voltages for driving the monitors to show images corresponding to the same display data. The same image, therefore, is successfully shown on different monitors, and the display quality is greatly improved owing to the claimed voltage calibration circuit.

1. A display controller for driving a monitor comprising:
a graphics chip for outputting a display data; and
a converter for converting the display data into a display driving voltage, the converter comprising:
a current mirror circuit for generating an output current according to a reference current and the display data, the output current and the reference current corresponding to a mirror ratio, the output current being delivered to the monitor for generating the display driving voltage; and
a voltage calibration circuit for modifying the mirror ratio according to the display driving voltage and a predetermined display driving voltage and adjusting the output current to drive the display driving voltage to approach the predetermined display driving voltage.

2. The display controller of claim 1 wherein the current mirror circuit comprises:
a first current route for delivering the reference current; and
a plurality of second current routes electrically connected to the first current route for delivering a plurality of mirror currents to an output port of the converter to form the output current.

3. The display controller of claim 2 wherein the voltage calibration circuit comprises:
a mirror ratio controller for controlling the mirror ratio;
a comparator for comparing the display driving voltage with the predetermined display driving voltage to generate a comparison result; and
a state machine for generating a setting value according to the comparison result and outputting the setting value to the mirror ratio controller to adjust the mirror ratio.

4. The display controller of claim 3 wherein the setting value is used for lowering the mirror ratio if the display driving voltage is greater than the predetermined display driving voltage, and the setting value is used for raising the mirror ratio if the display driving voltage is not greater than the predetermined display driving voltage.

5. The display controller of claim 3 wherein the mirror ratio controller comprises a plurality of mirror ratio setting units, and the mirror ratio controller activates a predetermined amount of mirror ratio setting units according to the setting value for adjusting the mirror ratio.

6. The display controller of claim 5 wherein each of the mirror ratio setting units corresponds to an identical adjustment magnitude when adjusting the mirror ratio.

7. The display controller of claim 5 wherein the mirror ratio setting units correspond to a plurality of adjustment magnitudes when adjusting the mirror ratio.

8. The display controller of claim 5 wherein each of the mirror ratio setting units is electrically connected to the first current route through a current mirror means.

9. The display controller of claim 3 wherein the state machine enters a first operating state for adjusting the setting value to drive the mirror ratio controller to lower the mirror ratio if the comparison result corresponds to a first logic level, and the state machine enters a second operating state for adjusting the setting value to drive the mirror ratio controller to raise the mirror ratio if the comparison result corresponds to a second logic level.

10. The display controller of claim 9 wherein the state machine will leave the first operating state and enter a third operating state for holding the setting value if the state machine stays at the first operating state, and the comparison result corresponds to the second logic level, and the state machine will leave the second operating state and enter the third operating state for holding the setting value if the state machine stays at the second operating state, and the comparison result corresponds to the first logic level.

11. A method for calibrating a display driving voltage comprising:
(a) converting a display data into an output current according to a reference current, the output current and the reference current corresponding to a mirror ratio, the output current being used for generating the display driving voltage; and
(b) comparing the display driving voltage and a predetermined display driving voltage for modifying the mirror ratio and adjusting the output current to drive the display driving voltage to approach the predetermined display driving voltage.

12. The method of claim 11 wherein the output current is generated from utilizing a current mirror means for delivering the reference current via a first current route and forming the output current through a plurality of mirror currents delivered via a plurality of second current routes.

13. The method of claim 12 wherein step (b) further comprises:
comparing the display driving voltage and a predetermined display driving voltage for generating a comparison result; and
generating a setting value according to the comparison result for adjusting the mirror ratio.

14. The method of claim 13 further comprising utilizing the setting value to lower the mirror ratio if the display driving voltage is greater than the predetermined display driving voltage, and utilizing the setting value to raise the mirror ratio if the display driving voltage is not greater than the predetermined display driving voltage.

15. The method of claim 13 further comprising enabling a first operating state for lowering the mirror ratio when the display driving voltage is greater than the predetermined display driving voltage, and the comparison result corresponds to a first logic level, and enabling a second operating state for raising the mirror ratio when the display driving voltage is not greater than the predetermined display driving voltage, and the comparison result corresponds to a second logic level.

16. The method of claim 15 further comprising disabling the first operating state and enabling a third operating state for holding the setting value when the first operating state is currently enabled, and the comparison result corresponds to the second logic level, and disabling the second operating state and enabling the third operating state for holding the setting value when the second operating state is currently enabled, and the comparison result corresponds to the first logic level.
